(19) United States
(12) Patent Application Publication
(10) Pub. No.: US 2018/0189685 A1
(43) Pub. Date: Jul. 5, 2018

(54) SYSTEM AND METHOD TO IDENTIFY A VEHICLE FIDUCIAL MARKER

(71) Applicants: GM GLOBAL TECHNOLOGY OPERATIONS LLC, Detroit, MI (US); GENERAL MOTORS, LLC., Detroit, MI (US)

(72) Inventors: Christopher L. Oesterling, Troy, MI (US); Aditya S. Kamini, Bloomfield Hills, MI (US); Donald K. Grimm, Utica, MI (US); Amy E. Hurley, Royal Oak, MI (US)

(21) Appl. No.: 15/398,026

(22) Filed: Jan. 4, 2017

(51) Int. Cl. G06Q 10/02; G06Q 30/06; G06K 9/78; G06K 9/62; G06T 15/20; G06T 19/00; G06K 9/20; G06K 9/00; H04M 1/725

(52) U.S. Cl. CPC G06Q 10/02; G06Q 30/0645; G06K 9/78; G06K 9/6202; H04M 1/72519; G06T 19/006; G06K 9/2063; G06K 9/00671; G06T 15/205

(57) ABSTRACT

A system and method having a number of technological elements, one of which being a controller, which causes improvements to the controller and creates significantly more than the original default controller functionality. The elements collaborating to cause the controller to operate a camera to record images of the visual content, operate a display to exhibit the visual content, perform a recognition module to identify the target object, produce identification results of the recognition module, compare the identification results to one or more vehicle share records, generate a 3D model having information based upon the comparison made of the identification results and vehicle share records, and operate the display to exhibit the 3D Model being overlaid onto the visual content.

### BACKGROUND

Vehicle sharing and self-serve vehicle rental services allow consumers to make reservations for station-based use of vehicles, particularly in urban environments. These rental vehicles are often located in reserved parking spaces identified with permanently mounted signs or markers. Ideally, a user picks up a vehicle from a reserved parking space and returns the vehicle to that parking space or a similarly marked space. However, as these parking spaces are often found in public parking lots, users are left with little to determine a vehicle's reservation status. This can frustrate the user and prevent them from renting the vehicle in a timely manner. Accordingly, it is desirable to provide a system and method for identifying vehicle reservation availability.

### SUMMARY

A method to generate reservation information is presented herein. The method includes the steps of: (a) providing a memory configured to include one or more executable instructions, the memory further configured to include one or more vehicle share records; (b) providing a controller configured to execute the executable instructions and communicate with the vehicle share records; (c) providing a mobile computing device including a display configured to exhibit information; (d) providing a camera on the mobile computing device, the camera configured to record images of a visual content in a digital form; (e) providing a recognition module in the memory, the recognition module configured to identify at least one target object of a portion of the visual content; (f) recording, via the camera, images of the visual content; (g) exhibiting, via the display, the visual content; (h) performing, via the controller, the recognition module to identify the visual content target object; (i) producing, via the controller, the identification results of the recognition module; (j) comparing, via the controller, the identification results to the vehicle share records; (k) generating, via the controller, a 3D model having information based upon the comparison made in step (j); and (l) exhibiting, via the display, the 3D Model overlaid onto the visual content.

The presented method may further include the steps of: (l) providing a transceiver on the mobile computing device, the transceiver configured to communicate one or more data transmissions; (m) communicating, via the transceiver, the identification results to the controller; and (o) after step (m), receiving, at the transceiver, the 3D Model. The memory and controller may be located in a call center. The presented method may further include the steps of: (m) based upon the outcome of step (l), requesting, via the controller, a reservation in compliance with the substance of the 3D model information; and (n) based upon step (m), generating, via the controller, a completed reservation from the reservation request. The portion of the visual content may be a fiducial marker. The fiducial marker may include a substantially square border portion. The target object may include at least one character or symbol and be positioned within the border portion of a fiducial marker. The 3D model information may include: the vehicle name, vehicle location, reservation cost, reservation availability facts, and reservation request options.

A system to generate vehicle-reservation information is also herein presented. The system includes a memory, controller, camera, mobile computing device, and recognition module. The memory is configured to include one or more executable instructions as well as one or more vehicle share records. The controller is configured to execute the executable instructions and communicate with the vehicle share records in the memory. The mobile computing device has a display configured to exhibit information. The camera is on the mobile computing device and is configured to record images of a visual content. The recognition module is located in the memory and configured to identify at least one target object of a portion of the visual content.

Moreover, the executable instructions enable the controller to: operate the camera to record images of the visual content; operate the display to exhibit the visual content; perform the recognition module to identify the target object; produce identification results of the recognition module; compare the identification results to the vehicle share records; generate a 3D model having information based upon the comparison made of the identification results and vehicle share records; and operate the display to exhibit the 3D Model being overlaid onto the visual content.

### DESCRIPTION OF THE DRAWINGS

The disclosed examples will hereinafter be described in conjunction with the following drawing figures, wherein like numerals denote like elements, and wherein:

FIG. 1 is a diagram illustrating an exemplary embodiment of a communication system according to an aspect of the system and method presented herein;

FIG. 2 is a schematic representation of an exemplary augmented reality-based fiducial marker recognition code segment according to an aspect of the system and method presented herein;

FIG. 3 is an exemplary application of an exemplary reservation module according to an aspect of the system and method presented herein;

FIG. 4 is an exemplary fiducial marker according to an aspect of the system and method presented herein;

FIG. 5 is another exemplary application of the exemplary reservation module according to an aspect of the system and method presented herein;

FIG. 6 is another exemplary application of the exemplary reservation module according to an aspect of the system and method presented herein; and

FIG. 7 is an exemplary schematic representation of the reservation module according to an aspect of the system and method presented herein.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs or code segments, a combinational logic circuit, and/or other suitable components that provide the described functionality.

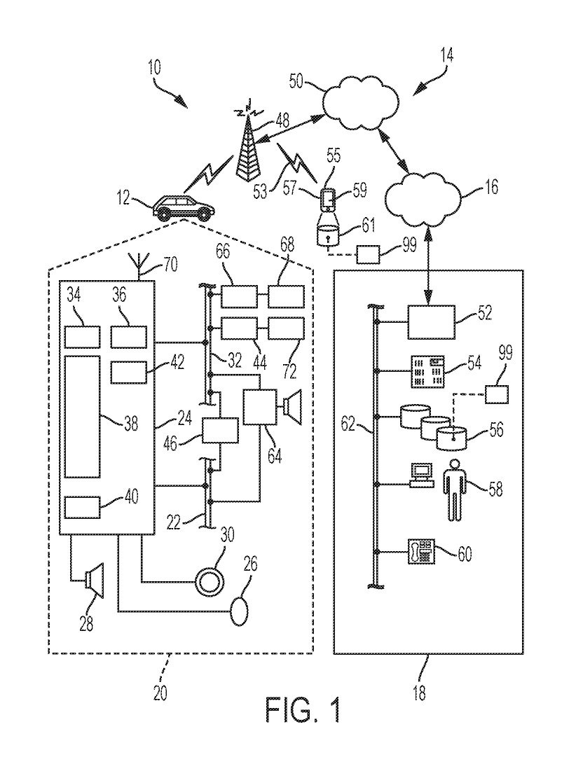

With reference to FIG. 1, there is shown a non-limiting example of a communication system 10 that may be used together with examples of the apparatus/system disclosed herein or to implement examples of the methods disclosed herein. Communication system 10 generally includes a vehicle 12, a wireless carrier system 14, a land network 16 and a call center 18. It should be appreciated that the overall architecture, setup and operation, as well as the individual components of the illustrated system are merely exemplary and that differently configured communication systems may also be utilized to implement the examples of the method disclosed herein. Thus, the following paragraphs, which provide a brief overview of the illustrated communication system 10, are not intended to be limiting.

Vehicle 12 may be any type of mobile vehicle such as a motorcycle, car, truck, recreational vehicle (RV), boat, plane, etc., and is equipped with suitable hardware and software that enables it to communicate over communication system 10. Some of the vehicle hardware 20 is shown generally in FIG. 1 including a telematics unit 24, a microphone 26, a speaker 28, and buttons and/or controls 30 connected to the telematics unit 24. Operatively coupled to the telematics unit 24 is a network connection or vehicle bus 32. Examples of suitable network connections include a controller area network (CAN), a media oriented system transfer (MOST), a local interconnection network (LIN), an Ethernet, and other appropriate connections such as those that conform with known ISO (International Organization for Standardization), SAE (Society of Automotive Engineers), and/or IEEE (Institute of Electrical and Electronics Engineers) standards and specifications, to name a few.

The telematics unit 24 is an onboard device that provides a variety of services through its communication with the call center 18, and generally includes an electronic processing device 38, one or more types of electronic memory 40, a cellular chipset/component 34, a wireless modem 36, a dual mode antenna 70, and a navigation unit containing a GNSS chipset/component 42. In one example, the wireless modem 36 includes a computer program and/or code segment adapted to be executed within electronic processing device 38.

The telematics unit 24 may provide various services including: turn-by-turn directions and other navigation-related services provided in conjunction with the GNSS chipset/component 42; airbag deployment notification and other emergency or roadside assistance-related services provided in connection with various crash and/or collision sensor interface modules 66 and collision sensors 68 located throughout the vehicle; and/or infotainment-related services where music, internet web pages, movies, television programs, videogames, and/or other content are downloaded by an infotainment center 46 operatively connected to the telematics unit 24 via vehicle bus 32 and audio bus 22. In one example, downloaded content is stored for current or later playback. The above-listed services are by no means an exhaustive list of all the capabilities of telematics unit 24, but are simply an illustration of some of the services that the telematics unit 24 may be capable of offering. It is anticipated that telematics unit 24 may include a number of additional components in addition to and/or different components from those listed above.

Vehicle communications may use radio transmissions to establish a voice channel with wireless carrier system 14 so that both voice and data transmissions can be sent and received over the voice channel. Vehicle communications are enabled via the cellular chipset/component 34 for voice communications and the wireless modem 36 for data transmission. Any suitable encoding or modulation technique may be used with the present examples, including digital transmission technologies, such as TDMA (time division multiple access), CDMA (code division multiple access), W-CDMA (wideband CDMA), FDMA (frequency division multiple access), OFDMA (orthogonal frequency division multiple access), etc.

Dual mode antenna 70 services the GNSS chipset/component 42 and the cellular chipset/component 34.

Microphone 26 provides the driver or other vehicle occupant with a means for inputting verbal or other auditory commands, and can be equipped with an embedded voice processing unit utilizing a human/machine interface (HMI) technology known in the art. Conversely, speaker 28 provides audible output to the vehicle occupants and can be either a stand-alone speaker specifically dedicated for use with the telematics unit 24 or can be part of a vehicle audio component 64. In either event, microphone 26 and speaker 28 enable vehicle hardware 20 and call center 18 to communicate with the occupants through audible speech. The vehicle hardware also includes one or more buttons and/or controls 30 for enabling a vehicle occupant to activate or engage one or more of the vehicle hardware components 20. For example, one of the buttons and/or controls 30 can be an electronic pushbutton used to initiate voice communication with call center 18 (whether it be a human such as advisor 58 or an automated call response system). In another example, one of the buttons and/or controls 30 can be used to initiate emergency services.

The audio component 64 is operatively connected to the vehicle bus 32 and the audio bus 22. The audio component 64 receives analog information, rendering it as sound, via the audio bus 22. Digital information is received via the vehicle bus 32. The audio component 64 provides amplitude modulated (AM) and frequency modulated (FM) radio, compact disc (CD), digital video disc (DVD), and multimedia functionality independent of the infotainment center 46. Audio component 64 may contain a speaker system, or may utilize speaker 28 via arbitration on vehicle bus 32 and/or audio bus 22.

The vehicle crash and/or collision detection sensor interface 66 is operatively connected to the vehicle bus 32. The collision sensors 68 provide information to the telematics unit via the crash and/or collision detection sensor interface 66 regarding the severity of a vehicle collision, such as the angle of impact and the amount of force sustained.

Vehicle sensors 72, connected to various sensor interface modules 44 (VSMs) in the form of electronic hardware components located throughout the vehicle and use the sensed input to perform diagnostic, monitoring, control, reporting and/or other functions. Each of the VSMs 44 is preferably connected by vehicle bus 32 to the other VSMs, as well as to the telematics unit 24, and can be programmed to run vehicle system and subsystem diagnostic tests. As examples, one VSM 44 can be an engine control module (ECM) that controls various aspects of engine operation such as fuel ignition and ignition timing and another VSM 44 can be a powertrain control module that regulates operation of one or more components of the vehicle powertrain. Another VSM 44 can be a body control module (BCM) that governs various electrical components located throughout the vehicle, like the vehicle's power door locks, engine ignition, and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle.

A passive entry passive start (PEPS) module is another type of VSM 44 that can be connected to the vehicle bus 32 and provide passive detection of the absence or presence of a passive physical key or a virtual vehicle key. When the passive physical key or smart phone 57 with virtual vehicle key approaches, the PEPS module 44 can determine if the passive physical key belongs to the vehicle 12 and/or (in some embodiments) determine if the virtual vehicle key is authorized/authentic. If the virtual vehicle key is authentic, the PEPS module 44 can send a command to the BCM permitting access to the vehicle 12. As is appreciated by those skilled in the art, the above-mentioned VSMs are only examples of some of the modules that may be used in vehicle 12, as numerous others are also possible.

Wireless carrier system 14 may be a cellular telephone system or any other suitable wireless system that transmits signals between the vehicle hardware 20 and land network 16. According to an example, wireless carrier system 14 includes one or more cell towers 48

Land network 16 can be a conventional land-based telecommunications network that is connected to one or more landline telephones, and that connects wireless carrier system 14 to call center 18. For example, land network 16 can include a public switched telephone network (PSTN) and/or an Internet protocol (IP) network, as is appreciated by those skilled in the art. Of course, one or more segments of the land network 16 can be implemented in the form of a standard wired network, a fiber or other optical network, a cable network, other wireless networks such as wireless local networks (WLANs) or networks providing broadband wireless access (BWA), or any combination thereof.

One of the networked devices that can communicate with the telematics unit 24 is a mobile computing device 57, such as (but not limited to) a smart phone, personal laptop computer or tablet computer having two-way communication capabilities, a wearable computer such as (but not limited to) a smart watch or glasses, or any suitable combinations thereof. The mobile computing device 57 can include computer processing capability, a transceiver 53 capable of communicating with wireless carrier system 14, a digital camera 55, a visual display 59, and/or a GPS module capable of receiving GPS satellite signals and generating GPS coordinates based on those signals. In some implementations, the display 59 also includes an interactive touch-screen graphical user interface. Digital camera 55 may include the ability to generate digital images which are bitmapped data representations of tangible objects captured and stored by generally known operations of camera 55. Examples of the mobile computing device 57 include the iPhone™ and Apple Watch™ each being manufactured by Apple, Inc. and the Droid™ smart phone that is manufactured by Motorola, Inc. as well as others.

Mobile device 57 may be used inside or outside of a vehicle (such as the vehicle 12 shown in FIG. 1), and may be coupled to the vehicle by wire or wirelessly. The mobile device also may be configured to provide services according to a subscription agreement with a third-party facility or wireless/telephone service provider. It should be appreciated that various service providers may utilize the wireless carrier system 14 and that the service provider of the telematics unit 30 may not necessarily be the same as the service provider of the mobile devices 57.

When using a short-range wireless connection (SRWC) protocol (e.g., Bluetooth Low Energy, Wi-Fi, etc.), mobile computing device 57 and telematics unit 24 may pair with each other (or link to one another) on a case-by-case basis when within a wireless range. This unique pairing may also allow mobile computing device 57 to act as a key fob to operate vehicle 12 through telematics unit 24. In order to pair in this manner, a set of unique encryption keys may be sent to both mobile computing device 57 and telematics unit 24. Call center 20 may moreover participate. For example, the call center 20 may generate the encryption keys as well as a corresponding access token for both telematics unit 24 and mobile computing device 57.

Call center 18 is designed to provide the vehicle hardware 20 with a number of different system backend functions and, according to the example shown here, generally includes one or more switches 52, servers 54, databases 56, advisors 58, as well as a variety of other telecommunication/computer equipment 60. These various call center components are suitably coupled to one another via a network connection or bus 62, such as the one previously described in connection with the vehicle hardware 20. Switch 52, which can be a private branch exchange (PBX) switch, routes incoming signals so that voice transmissions are usually sent to either advisor 58 or an automated response system, and data transmissions are passed on to a modem or other piece of telecommunication/computer equipment 60 for demodulation and further signal processing. The modem or other telecommunication/computer equipment 60 may include an encoder, as previously explained, and can be connected to various devices such as a server 54 and database 56. Database 56 could be designed to hold one or more vehicle-share services records (i.e., vehicle reservation information) having information such as, but not limited to, vehicle-share services reservation account records, vehicle-share vehicle records, reservation profile records (e.g., a reservation calendar), renter behavioral pattern records, or any other pertinent vehicle-share services information. This backend information being stored and generated could moreover be written in SQL (structured query language). One embodiment of the backend information may be created such that each record is organized through a tabular form (spreadsheet).

For example, the user of mobile computing device 57 may create their own personalized vehicle-share services reservation account (“reservation account”) to be stored in database 56. The user may perform tasks to create this account through a variety of devices such as remote computer 18 and mobile computing device 57 or through live advisor 86 at call center 20. The user account may be accessible on server 82 (i.e., to support backend functions). Call center 20 may also access one or more additional remote servers and/or remote databases (e.g., Department of Motor Vehicles databases) to receive information in support of the reservation account.

The user account may include validating data to verify and/or validate that future login attempts are secure (e.g., granting access only to the user). The validating data may include an account username and account password as well as user information (e.g., driver's license number), mobile computing device information such as, for example, the unique mobile device identifier (i.e., serial number). The user account may additionally store a variety of user preferences.

The mobile computing device 57 may receive a software module 99 (“fiducial marker recognition module” or “recognition module”) which may be further associated with their reservation account. For example, the user of the mobile device 57 may visit an online software application store or web-service and download the recognition module 99 therefrom. The mobile computing device 57 may moreover install the frontend piece of the recognition module 99 onto mobile memory 61 of the mobile computing device 57. Module 99 may moreover include one or more graphical user interfaces (GUIs) to be exhibited through display 59, and which include one or more prompts to instruct the user to provide information (e.g., validating data) to support user account creation.

Recognition module 99 may be configured to assist a vehicle-share system user (mobile computing device user) in reserving at least one vehicle 12 by operatively accessing and communicating with the backend vehicle-share services records in database 56. Module 99 may moreover have access to digital camera 55, discussed below, to assist a user when identifying a specific vehicle 12.

Although the illustrated example has been described as it would be used in conjunction with a call center 18 that is manned, it will be appreciated that the call center 18 can be any central or remote facility, manned or unmanned, mobile or fixed, to or from which it is desirable to exchange voice and data.

### Fiducial Marker Recognition Module

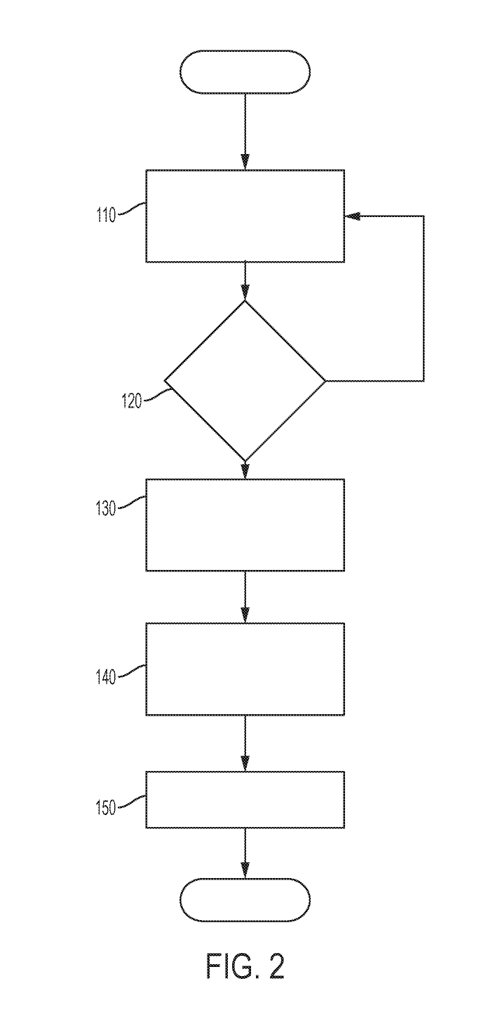

FIG. 2 shows an exemplary schematic representation of an embodiment of at least one code segment to form a system flow for an augmented reality-based fiducial marker recognition module 99. Fiducial marker recognition module 99 may be performed as an augmented reality program to identify at least one target object (e.g., characters) in visual content (e.g., fiducial marker), and which may be incorporated into to an embodiment of the system and method herein. Augmented reality should be understood to superimpose virtual computer-generated objects over a real-time view of a physical, real-world environment of an image captured by camera 55.

As illustrated in FIG. 2, at step 110, module 99 (system flow) takes an input which is generally one or more images of the visual content that have been previously recorded by camera 55 under the auspices of recognition module 99. The visual content input is then converted into binary form for the images. This binarization may use a fixed threshold value (e.g., a value of 11) as is generally known in the art. Module 99 then seeks out a 2D object representing fiducial marker 76 within the binarized digital content of one or more of the images.

At step 120, for image selection purposes, module 99 determines if one or more border portions 78 of the 2D object are found within the binarized version of the visual content. In doing so, module 99 will recognize segments of code pixels being in a uniform binary digit (e.g., either “1” or “0”) as those which could potentially represent a fiducial marker object. For each of these recognized segments, module 99 will implement a safeguard heuristic check to ascertain whether the segment has a sufficient size and shape. For example, if the heuristic check determines the code segment shape is not square or has at least one significant break (i.e., an opening in the binarized border), the heuristic check would determine the code region is not of a sufficient shape (e.g., square). If a sufficient border is found, module 100 will move to step 130. Otherwise, module 99 will return to step 110 and select a different binarized image to find a binarized border portion 78. Aspects of this detection process are further discussed in Rekimoto, J., “Matrix: A Realtime Object Identification and Registration Method for Augmented Reality”, Proc. APCHI '98, 1998, pp. 1-6, which is hereby incorporated by reference in its entirety.

At step 130, module 99 estimates the position of camera 55. In doing so, a mathematically generated transformation matrix is calculated to represent a real-world translation and rotation of camera 55—as is generally known in the art. The matrix calculations may be made through known image points found in the visual content such as, for example, the distinct corners of border portion 78. The known mathematical calculations to create transformation matrices are also further discussed in Rekimoto, J., “Matrix: A Realtime Object Identification and Registration Method for Augmented Reality” (as has been previously incorporated herein).

At step 140, the target objects are found within border portion 78 and then compared with the information within the vehicle-share services records to find a match. In finding the target objects, a quad-tangle may be fitted over the code region and this quad-tangle may be conducted through a generally known square methodology. Based on the estimated quad-tangle position, a transformation parameter may then be calculated which should correct the rotation effect in the binarized visual content, motion, and perspective transformation effects of camera 55, as well as filters any distorted visual content represented within the code segments. A known feature extraction methodology (e.g., optical character recognition scanning) may in turn be implemented to isolate and translate the binarized text of the target object (e.g., “123456-M” as shown) into a value. An error check may then be applied to certify the target object.

The target object value is then sent as identification results to be compared with the vehicle-share records. Thus, the processed fiducial marker 76 can be used to look up the vehicle-share records for a corresponding fleet vehicle 12. Information from these records may then be searched, selected, and accessed from either mobile memory 61 or databases 56. To assist in this effort, the records may each include a distinguishable data tag that corresponds with the identification results. For example, if the identification results produce the characters and symbols “123456-M” recognition module 99 may search through the records for a tag that is “123456-M” (or the equivalent in the respective source code language).

When accessed, module 99 will verify that each of the matching records are logical. For example, module 99 may compare all variable information in the accessed record against the identification results (discussed below). If any information is determined to be inadequate (e.g., the corresponding reservation profile record being missing) or illogical, for instance, in light of the records information (e.g., the record shows its respective vehicle to be parked at a remote location), reservation module 99 may notify the user or call center 20. Reservation module 99 may also again search through the records, select, and access another record that may have adequate variable information for comparison purposes.

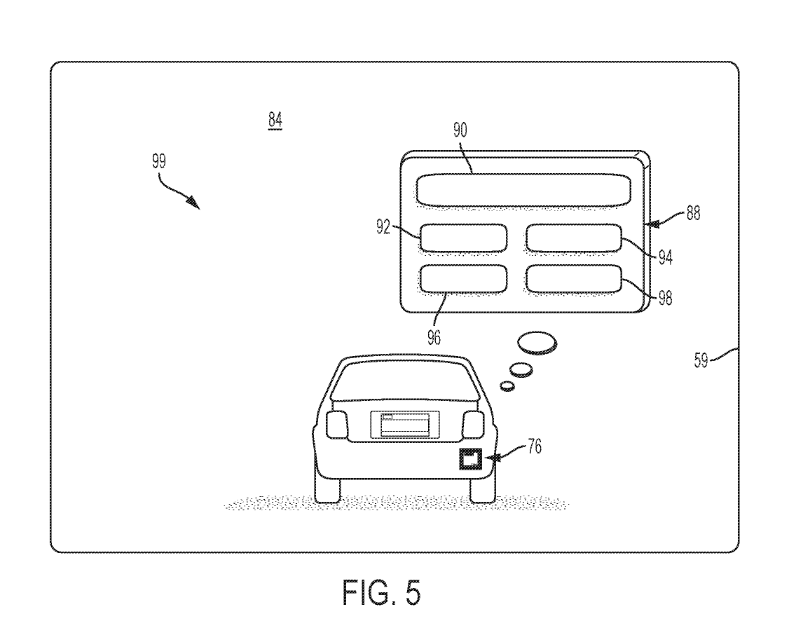

In step 150, with additional reference to FIG. 5, a digital 3D model of reservation information 88 may be retrieved from the matching records and later rendered in the displayed visual content of the digital image. As such, when a mobile device 57 user views the respective recognition module 99 GUI, they see a homogenous 3D graphic model or the like which is superimposed onto a real-world stream of recorded images (i.e., the visual content). The 3D graphic model may be drawn in the foreground of the recorded images and tracked against image movements, which causes the 3D graphic model to seem connected and overlaid onto to the image background.

Reservation module 99 may display this 3D model 88 in a pixelated format through an aspect shown as a reservation information GUI 84. An embodiment of the 3D model 88 may include variables such as, but not limited to, the vehicle name 90, vehicle location 92, reservation cost 94, reservation availability facts 96, and reservation request options 98. For example, the vehicle name 90 may include generic descriptive information such as, but not limited to, the vehicle year (e.g., “2016”) and model (e.g., “Chevrolet Tahoe”), vehicle color (e.g., “White”), vehicle-share system registration number (e.g., “#M28” or “DLT-45XX”), or it may even include a familiar, commercially distinctive, or humorous name for the vehicle (e.g., “The Jenny Lee”, “Betsy Matilda”, “Nelly”, etc.). Vehicle location 92 may include the current location of the vehicle, the location of a designated vehicle parking location, or a parking location in which the vehicle is typically located. Reservation cost 94 may include cost information corresponding to a selected time duration (e.g., “$25 USD for 2 hours”, “$55 USD for 8 PM-10 PM, Friday, November 3rd”, etc.). Reservation availability facts 96 may include calendar scheduling information regarding the vehicle availability (e.g., “NOT AVAILABLE—10 PM-2 AM, Friday, November 3^{rd}”) or pick up/drop off requirements (“Pick Up at 123 El Segundo Way” and “Drop Off at 345 Main Street”). It should be understood that each piece of the above variable information may come from an individual corresponding vehicle-share services record.

Reservation request options 98 may additionally include selections such as, but not limited to reservation time extensions, fuel information, trip information, live advisor 58 contacting options, and reservation cost negotiation options. It should be understood that the list of the vehicle name 90, vehicle location 92, reservation cost 94, reservation availability facts 96, and reservation request options 98 is not to be considered an exhaustive list and other reservation information may be displayed. 3D Model 88 may further include a pixilated version of vehicle 12.

### Method

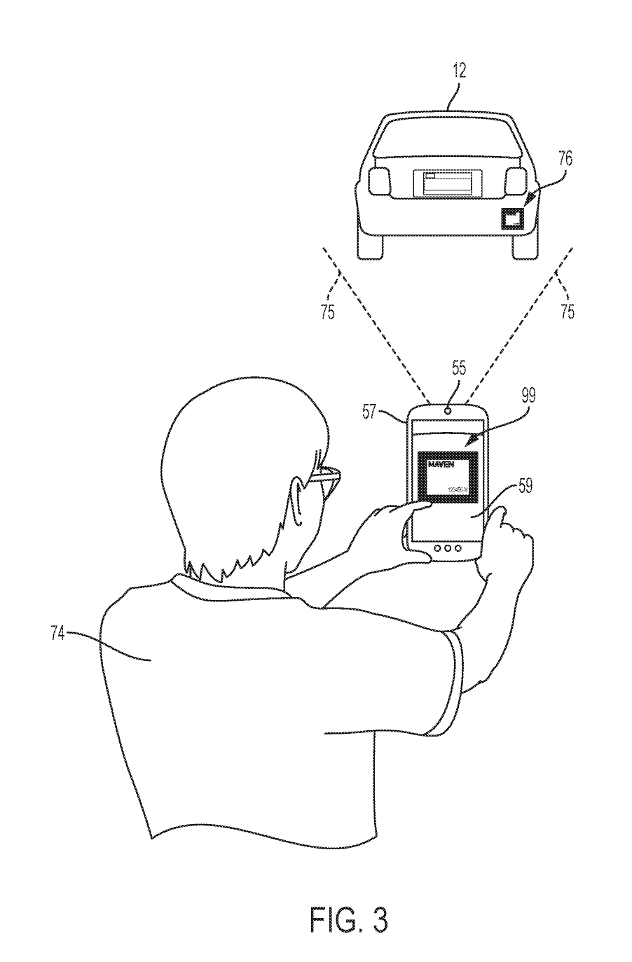

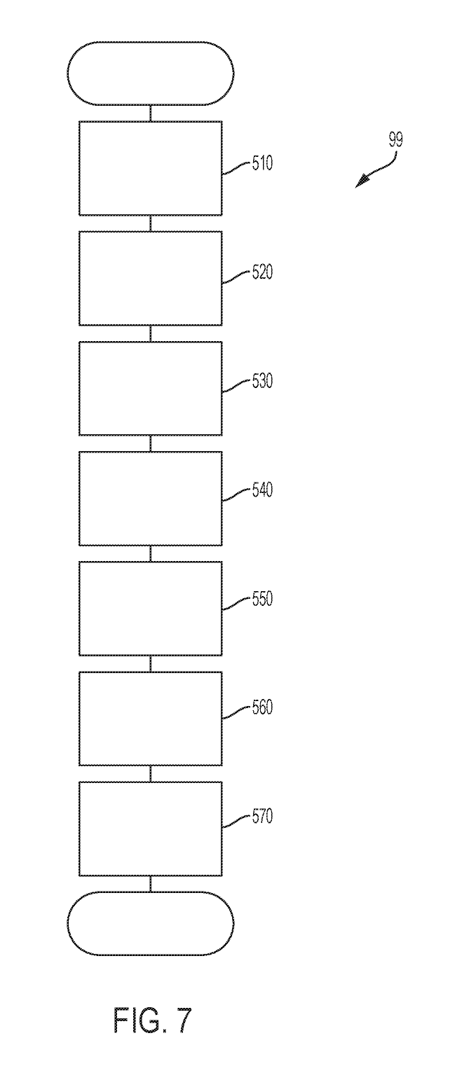

Turning now to and comparing FIGS. 3 through 7, there can be seen an application of a method to generate reservation information through recognition module 99. One or more aspects of this method may be executed through controller 52, for example, implementing the backend functionality of the part of module 99 stored on database 56 or mobile memory 61. Aspects may otherwise be executed through mobile computing device 57, for example, implementing the frontend functionality of the part of recognition module 99 stored on mobile memory 61. It should also be appreciated that aspects of this method may be conducted after a user accesses their reservation account via module 99.

With reference to FIG. 3, in step 510, a user 74 of mobile computing device 57 begins use of recognition module 99 by pointing the camera's field of vision 75 in the general direction of a vehicle 12 in which they desire to reserve (i.e., the desired visual content). In this step, user 74 may adjust the lens of camera 55 to focus upon the targeted portion of the vehicle 12 which, for example, is fiducial marker 76 in such a way to accurately capture the characters and symbols within a border portion 78 (i.e., target object 82).

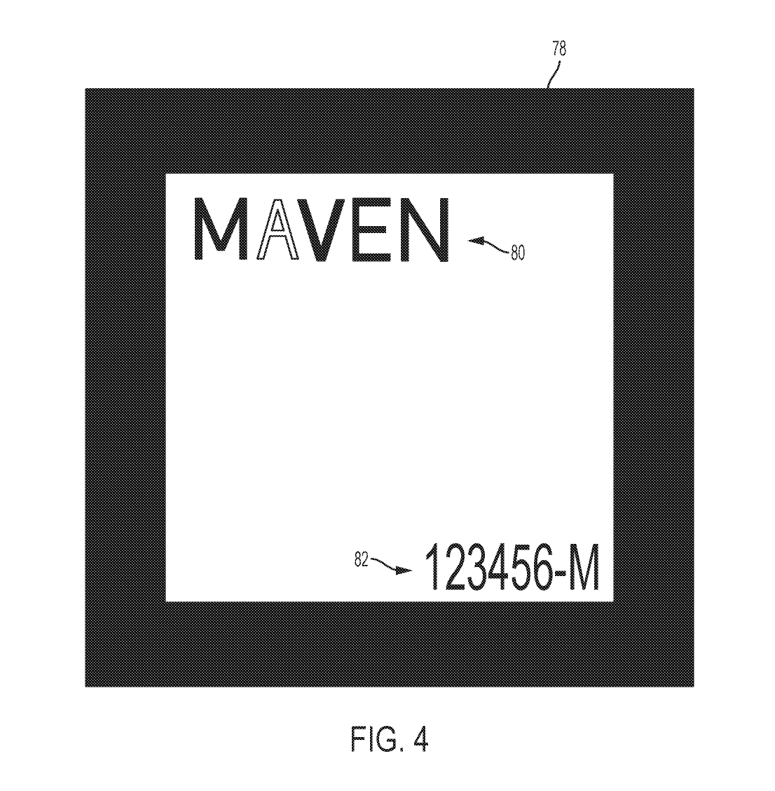

With reference to FIG. 4, in further detail, fiducial marker 76 is a detectable feature placed on vehicle 12 (e.g., via adhesives) and should have a substantially square and continuous border portion 78. As discussed above, fiducial marker recognition module 99 may not recognize a fiducial marker 76 when substantial interruptions occur in the scheme of border portion 78. Thus, this border should also be of a uniform color (e.g., black or white) which properly contrasts the color of the surrounding vehicle body. The border thickness should also be noticeable to module 99 which may, for example, be approximately 25% of the edge length of fiducial marker 76 in its entirety. In this way, user 74 may desire to align camera 55 to reflect marker 76 being displayed as a square (and not so offset it seems to have some other shape) and does not include a border with artificial border interruptions.

One exemplary constraint of fiducial marker 76 is that the area within border portion 78 (the pattern/marker region) should be rationally asymmetric and may blend into the border. As shown, for example, pattern section 80 is offset from the central line of fiducial marker 76 as well as located on the opposite side as target object 81. The pattern area may moreover be colorless (black and white) or it may have a color scheme. However, when a color scheme is implemented, the recognition module should be configured to sense the colors with sufficient accuracy.

In step 520, once the backside of vehicle 12 is in focus, user 74 can operate recognition module 99 (via touch-screen GUI feature of display 59) to display and digitally record images of the visual content. In step 530, module 99 identifies fiducial marker 76 in the digitally recorded images and designates the fiducial marker 76 as a critical aspect of the visual content. In step 540, one or more recorded critical aspects of digital images may then be sent to mobile memory 61 or databases 56, depending on the embodiment, as identification results. In this step, these digital images may moreover be stored in a digital format (e.g., .jpg). For instance, when module 99 is configured to implement all methodology aspects via mobile computing device 57, the digital images may simply remain in mobile memory 61 and may be stored there for more permanent applications. However, in those embodiments in which recognition module 99 is configured to implement one or more aspects as backend functionality, the images may be transmitted to databases 56 by transceiver 53 and may be stored in this location for more permanent applications. It should be understood that any non-critical digital images may be discarded before being downloaded to mobile memory 61 or databases 56 (e.g., those of which have substance that does not adequately reflect target object 81).

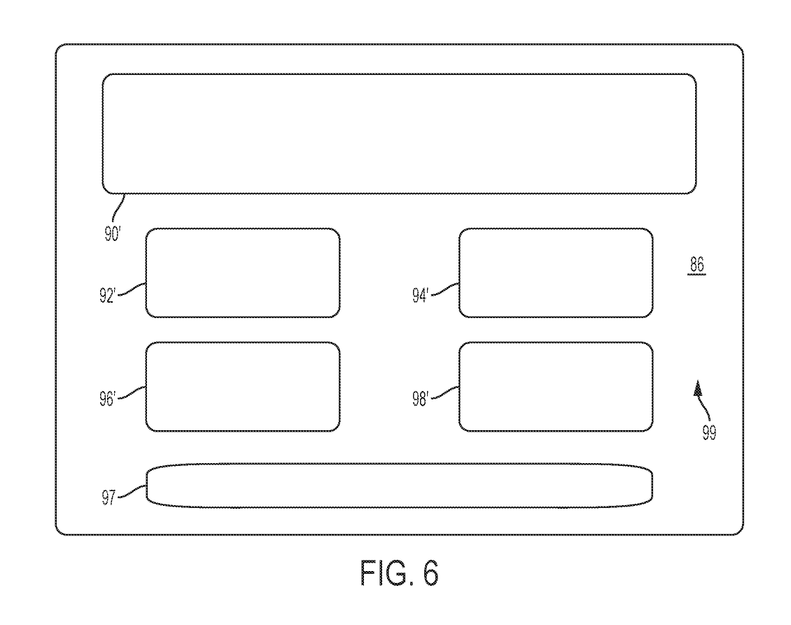

As illustrated in FIG. 5, in step 550, as discussed above, recognition module 99 will perform the required steps to produce the corresponding 3D model to be superimposed onto the displayed visual content, as discussed above. With reference to FIG. 6, in step 560, based on the outcome of step 550, module 99 may display reservation-confirmation information, in a pixelated format through an optional aspect shown as a reservation confirmation GUI 86. Based upon the personal availability of user 74, in an optional step and in response to the reservation parameters set forth by the variable information in the 3D model 88, user 74 may use reservation information screen 86 to request a vehicle reservation. For example, when the schedule of user 74 and the reservation parameters align, the user may desire to reserve vehicle 12 accordingly and generate a reservation request through the use of a virtual confirmation button 97. As a result, barring any unforeseen consequences, from the reservation request, a completed reservation may be derived by module 99 and the vehicle-share services records may be updated accordingly. As can be seen, reservation confirmation screen 86 may incorporate versions of the reservation information 88 variables (the vehicle name 90′, vehicle location 92′, reservation cost 94′, reservation availability facts 96′, and reservation request options 98′) as confirmation information, but other configurations of reservation confirmation GUI 86 may include other non-disclosed variables.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While various exemplary embodiments have been presented in the foregoing detailed description, it should be appreciated that a vast number of variations exist. It should also be appreciated that the exemplary embodiments are only examples, and are not intended to limit the scope, applicability, or configuration of the disclosure in any way. Rather, the foregoing detailed description will provide those skilled in the art with a convenient road map for implementing the exemplary embodiments. It should be understood that various changes can be made in the function and arrangement of elements without departing from the scope of the disclosure as set forth in the appended claims and the legal equivalents thereof.

1. A method to generate reservation information, the method comprising:
(a) providing a memory configured to comprise one or more executable instructions, the memory further configured to comprise one or more vehicle share records;
(b) providing a controller configured to execute the executable instructions and communicate with the vehicle share records;
(c) providing a mobile computing device comprising a display configured to exhibit information;
(d) providing a camera on the mobile computing device, the camera configured to record images of a visual content;
(e) providing a recognition module in the memory, the recognition module configured to identify at least one target object of a portion of the visual content;
(f) recording, via the camera, images of the visual content;
(g) exhibiting, via the display, the visual content;
(h) performing, via the controller, the recognition module to identify the visual content target object;
(i) producing, via the controller, the identification results of the recognition module;
(j) comparing, via the controller, the identification results to the vehicle share records;
(k) generating, via the controller, a 3D model comprising information based upon the comparison made in step (j); and
(l) exhibiting, via the display, the 3D Model superimposed over at least a portion of the visual content.

2. The method of claim 1, further comprising:
(l) providing a transceiver on the mobile computing device, the transceiver configured to communicate one or more data transmissions;
(m) communicating, via the transceiver, the identification results to the memory; and
(o) after step (m), receiving, at the transceiver, the 3D Model.

3. The method of claim 2, wherein the memory is located in a call center.

4. The method of claim 1, further comprising:
(m) based upon the outcome of step (l), requesting, via the controller, a reservation in compliance with the substance of the 3D model information; and
(n) based upon step (m), generating, via the controller, a completed reservation from the reservation request.

5. The method of claim 1, wherein the portion of the visual content is a fiducial marker.

6. The method of claim 5, wherein the fiducial marker comprises a substantially square border portion.

7. The method of claim 6, wherein the target object is at least one character or symbol positioned within the border portion of a fiducial marker.

8. The method of claim 1, wherein the 3D model information comprising:
vehicle name;
vehicle location;
reservation cost;
reservation availability facts; and
reservation request options.

9. A system to generate vehicle-reservation information, the system comprising:
a memory configured to comprise one or more executable instructions, the memory further configured to comprise one or more vehicle share records;
a controller configured to execute the executable instructions and communicate with the vehicle share records;
a mobile computing device comprising a display configured to exhibit information;
a camera on the mobile computing device, the camera configured to record images of a visual content;
a recognition module in the memory, the recognition module configured to identify at least one target object of a portion of the visual content;
wherein the executable instructions enable the controller to:
operate the camera to record images of the visual content;
operate the display to exhibit the visual content;
perform the recognition module to identify the target object;
produce identification results of the recognition module;
compare the identification results to the vehicle share records;
generate a 3D model comprising information based upon the comparison made of the identification results and vehicle share records; and
operate the display to exhibit the 3D Model being superimposed over at least a portion of the visual content.

10. The system of claim 11, further comprising:
a transceiver on the mobile computing device, the transceiver configured to communicate one or more data transmissions, the data transmissions comprising the identification results; and
wherein the executable instructions enable the controller to:
communicate the identification results via the transceiver to the memory; and
receive the 3D Model from the transceiver.

11. The system of claim 10, wherein the memory is located in a call center.

12. The system of claim 9, wherein the executable instructions further enable the controller to:
request a vehicle reservation when a compliance exists with the substance of the 3D model information; and
generate a completed vehicle reservation from the vehicle reservation request.

13. The system of claim 9, wherein the portion of the visual content is a fiducial marker.

14. The system of claim 13, wherein the fiducial marker comprises a substantially square border portion.

15. The system of claim 14, wherein the target object is at least one character or symbol positioned within the border portion of a fiducial marker.

16. The system of claim 9, wherein the 3D model information comprising:
vehicle name;
vehicle location;
reservation cost;
reservation availability facts; and
reservation request options.

17. A non-transitory and machine-readable medium having stored thereon one or more executable instructions to generate a 3D model, which when provided a mobile computing device with a camera and display and executed by at least one machine, causes the machine to:
operate the camera to record images of a visual content;
operate the display to exhibit the visual content;
perform a recognition module to identify at least one target object of a portion of the visual content;
produce identification results of the recognition module;
compare the identification results to one or more vehicle share records;
generate a 3D model comprising information based upon the comparison made of the identification results and vehicle share records; and
operate the display to exhibit the 3D Model being superimposed over at least a portion of the visual content.

18. The non-transitory and machine-readable medium of claim 17, wherein the portion of the visual content is a fiducial marker.

19. The non-transitory and machine-readable medium of claim 17, wherein the fiducial marker comprises a substantially square border portion.

20. The non-transitory and machine-readable medium of claim 17, wherein the target object is at least one character or symbol positioned within the border portion of a fiducial marker.
